(19) United States
(12) Patent Application Publication
(10) Pub. No.: US 2011/0097543 A1
(43) Pub. Date: Apr. 28, 2011

(54) PATTERN PROCESSES AND DEVICES THEREOF

(76) Inventors: Jennifer Hoyt Lalli, Blacksburg, VA (US); William Harrison, Riner, VA (US); Adam Bingaman, Blacksburg, VA (US)

(21) Appl. No.: 12/762,990

(22) Filed: Apr. 19, 2010

Related U.S. Application Data
(60) Provisional application No. 61/170,105, filed on Apr. 17, 2009.

(51) Int. Cl. B32B 3/30; B32B 5/16; B05D 3/14; B82Y 30/00

(52) U.S. Cl. 428/141; 428/172; 427/466; 977/773

(57) ABSTRACT

An apparatus may include a nano-particle layer and/or a linking agent layer. An apparatus may include a nano-particle layer bonded to a linking agent layer. An apparatus may include a substantially smooth surface. An apparatus may include a nano-particle layer and/or a linking agent layer which may be electrostatically etched to form a precise etched portion. An apparatus may have a precise etched portion including a pattern, for example a coil print pattern having a bend. An apparatus may include a nano-particle layer and/or a linking agent layer bonded to a shape memory layer. An apparatus may include a relatively even distribution of heat and/or current, and/or a predetermined heat and/or current path. A method may include forming a nano-particle layer and/or a linking agent layer. A method may include electrostatically etching a nano-particle layer and/or a linking agent layer.

The present application claims priority to U.S. Provisional Patent Application No. 61/170,105 (filed Apr. 17, 2009), which is hereby incorporated by reference in it's entirety.

### BACKGROUND

It may be desirable to pattern materials, which may be tailored to exhibit predetermined properties, at a relatively low cost and/or high precision. However, patterning processes and/or devices thereof may suffer from one or more drawbacks. Etching metal materials may require relatively costly and/or dangerous fluids throughout and/or after an etching process, which may also impact the operation of a device. Etching sputter coated films may not produce relatively discrete and/or defined patterns. Printing on and/or over materials may require relatively costly fluids and/or pre-printing steps. Etching and/or printing processes may not be configured and/or employed to account for the properties of a substrate and/or device operation.

Patterning processes and/or devices thereof may be relevant in a variety of technologies, for example in shape memory applications. Shape memory is the ability of a material to remember its original shape after mechanical deformation. Shape memory material may have an initial shape, may be heated above its glass transition temperature and strained (i.e. deformed) such that the material may maintain its deformed shape if it is cooled below its glass transition temperature while under the mechanical strain that caused the deformation, and/or may resume its original shape if the shape memory material is again heated above its glass transition temperature while unstrained. Thus, shape memory material should be heated in an effective and efficient manner while maximizing repeatability, efficiency, effectiveness, dependability of operation.

Heating may be accomplished by an electrode, which may be formed on and/or over shape memory material to produce heat. For example, a voltage and/or current may be applied to an electrode to generate heat through shape memory material through the inherent electrical resistance of shape memory material. However, electrodes may not be configured to account for the properties of a substrate and/or device operation. A conductive thin film (e.g. a sputter coated thin gold film) may crack and/or become delaminated or otherwise structurally deteriorate when strained. Thus, when shape memory material is transformed back its original shape, the electrode may be permanently damaged, which may compromise the repeatability, efficiency, effectiveness, and/or dependability of operation. Electrodes may also minimize efficiencies and/or device operation since current and/or heat paths may not be defined and/or predetermined.

Therefore, there is a need for tailored materials and/or patterning processes which may efficiently and effectively account for the properties of a substrate and/or device operation, for example in shape memory material applications. There is a need to predictably pattern materials at a relatively low cost and/or high precision in a variety of technologies, for example in radio frequency identification applications, display applications, integrated circuits, optoelectronic applications, and the like. There is a need for pattern processes and/or patterned materials thereof which may enable configuring electrical, mechanical and/or thermal properties.

### SUMMARY

Embodiments relate to an apparatus (e.g. a shape memory device, a display device, a radio frequency identification device, an integrated circuit, an optoelectronic device, etc.) which may include a nano-particle layer, a linking agent layer, and/or a shape memory layer. Embodiments relate to pattern processes which may efficiently and effectively account for the properties of a substrate and/or device operation at a relatively low cost and/or high precision. Embodiments related to employing patterning processes and/or materials to maximize configuring electrical, mechanical and/or thermal properties.

According to embodiments, an apparatus may include a nano-particle layer. In embodiments, a nano-particle layer may include an individual particle. In embodiments, a nano-particle layer may include a nano-size particle of a metal, metal oxide, inorganic, organic, and/or semiconductor material. In embodiments, nano-size particles may include clusters, for example gold clusters, each having a diameter less than approximately 1000 nanometers.

According to embodiments, an apparatus may include a linking agent layer. In embodiments, a linking agent layer may include an elastomeric polymer. In embodiments, a nano-particle layer may be bonded to a linking agent layer through a variety of interactions, including electrostatic bonding and/or covalent bonding. In embodiments, a nano-particle layer may be bonded to sites of an elastomeric polymer. In embodiments, a nano-particle layer and/or a linking agent layer may be formed over any substrate, for example over a surface of a fiber.

According to embodiments, an apparatus may include a shape memory material layer. In embodiments, a nano-particle layer and/or a linking agent layer may be bonded to a shape memory material layer through a variety of interactions, including electrostatic bonding and/or covalent bonding. In embodiments, an individual particle of a nano-particle layer and/or sites of an elastomeric polymer may be bonded to sites of a shape memory material layer.

According to embodiments, an apparatus may have a nano-particle layer including an electrode. In embodiments, an electrode may be configured to generate heat, for example to heat a shape memory material, through electricity. In embodiments, since current may travel in a path of least resistance, substantially well-defined patterns may enable directed heating, and/or heating over large areas of an electrically conductive nanocomposite, for example for low power shape change. In embodiments, heat generated may raise a shape memory material layer above the glass transition temperature of the shape memory material layer to induce deformation. In embodiments, an electrode may be substantially resilient to deformation of a linking agent layer and/or a shape memory layer, for example due to individual bonding of individual particles of a nano-particle layer to a linking agent layer and/or a shape memory material layer.

According to embodiments, a nano-particle layer and/or a linking agent layer may be etched to form a substantially well-defined pattern. In embodiments, a relatively smooth surface may be formed without a need for additional processing, for example planarization processes and/or surface treatments. In embodiments, a surface of an apparatus may have an average surface roughness less than approximately 100 nanometers, for example approximately 5 nanometers. In embodiments, processes may be employed to pattern a relatively smooth surface in a relatively predictable manner such that electrical, mechanical and/or thermal properties may be configured.

According to embodiments, a nano-particle layer and/or a linking agent layer may be electrostatically etched to form a substantially well-defined pattern. In embodiments, an electrostatically etched nano-particle layer and/or a linking agent layer may include a precise etched portion, which may result from breakdown of an electrostatic field through an electric arc. In embodiments, a precise etched portion may include an area substantially equal to the area of an etching portion of an electrostatic etching tool. In embodiments, a precise etched portion may include a print pattern, such as a coil print having a bend. In embodiments, a substantially well-defined pattern may enable a predetermined current and/or heat path. In embodiments, a relatively even distribution of heat and/or current, and/or a predetermined heat and/or current path, may be provided.

According to embodiments, pattern processes and/or materials may be employed in a wide range of technologies, for example in aerospace, automotive, electronics, and entertainment. In embodiments, a substantially well-defined pattern on and/or over a material tailored to exhibit conductive properties may be employed in radio frequency identification applications, for example when relatively precise antenna patterns may be desired. In embodiments, a relatively well-defined pattern on and/or over a material tailored to exhibit conductive properties may be employed in integrated circuits, for example to form interconnections and/or contact pads.

In embodiments, a relatively well-defined pattern on and/or over a material tailored to exhibit conductive properties may be employed in display technologies, for example to form electrodes of a liquid crystal display. In embodiments, for example in display technologies and/or optoelectronic technologies, a nano-particle layer and/or a linking agent layer may be substantially transparent. In embodiments, shape memory materials may be heated using substantially well-defined patterns, for example to inflate a relatively large antenna in space that is stored in a relatively small protected compartment in the satellite during launch and orbiting of the satellite, with repeatable and dependable deployment that is not compromised by deteriorating electrodes.

### DRAWINGS

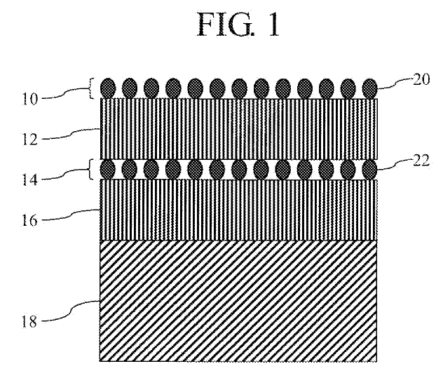

Example FIG. 1 illustrates a cross-section of a material in accordance with embodiments.

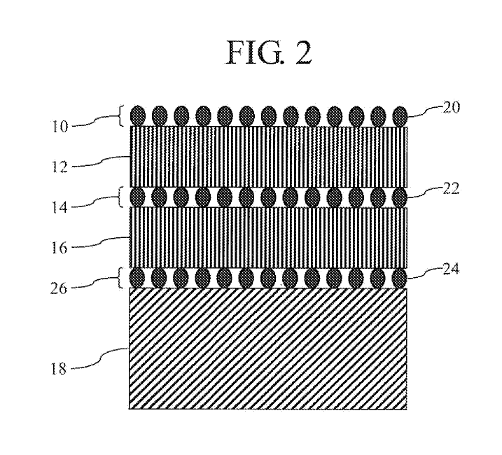

Example FIG. 2 illustrates a cross-section of a material in accordance with embodiments.

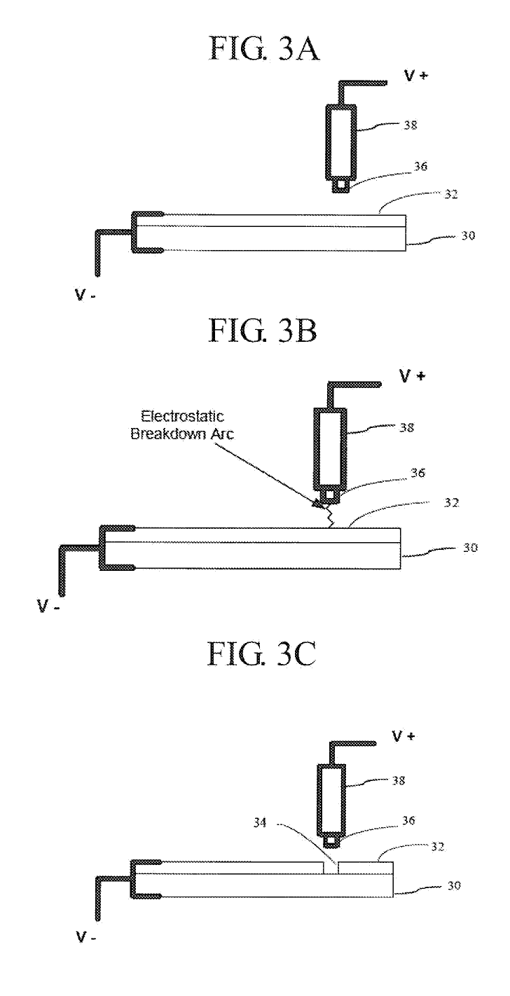

Example FIG. 3A to FIG. 3C illustrates an etching process and/or a side view of a material in accordance embodiments.

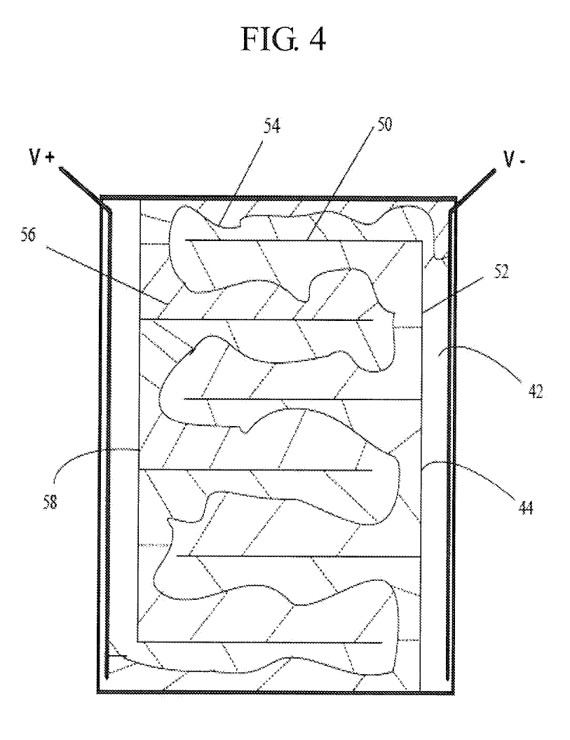

Example FIG. 4 illustrates a plan view of a material in accordance with embodiments.

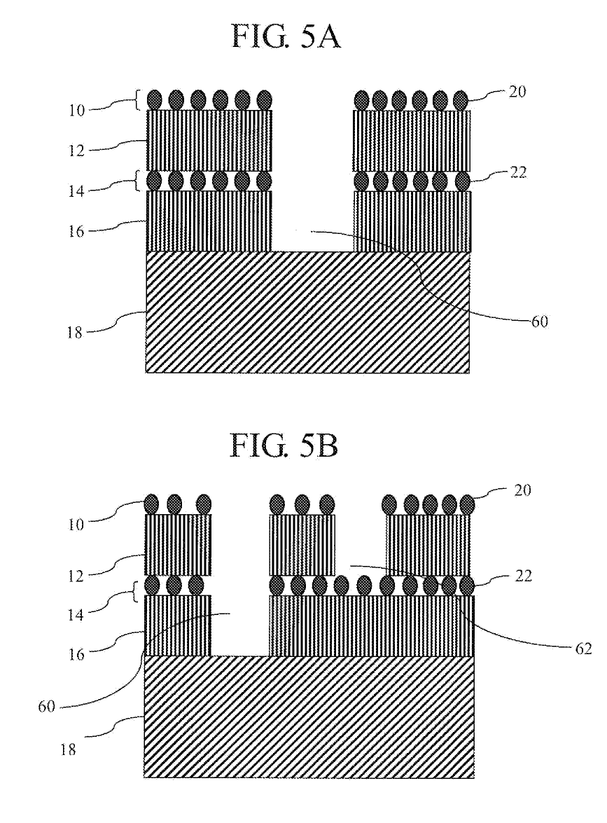

Example FIG. 5A to FIG. 5B illustrates a cross-section of a precise etched portion in accordance embodiments.

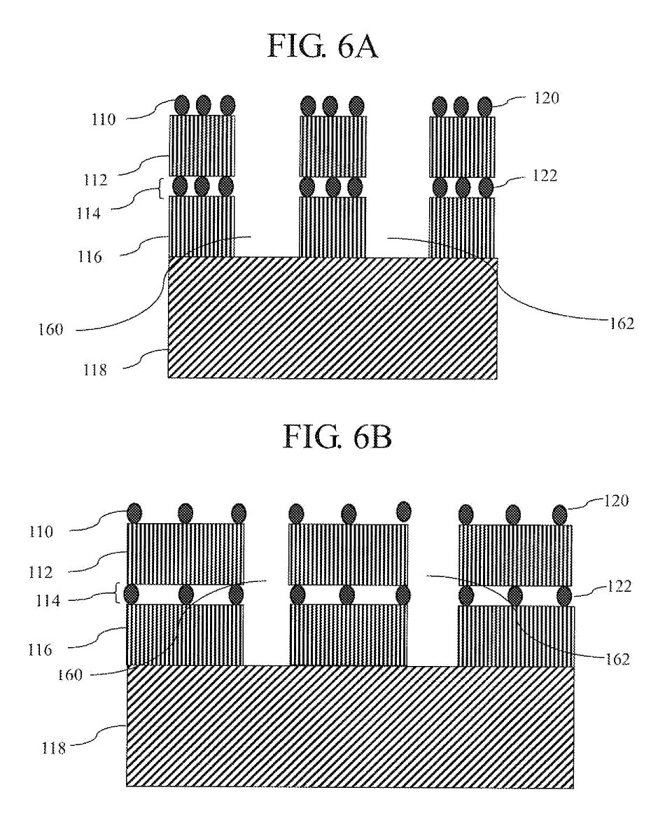

Example FIG. 6A to FIG. 6B illustrates a cross-section of a material in accordance with embodiments.

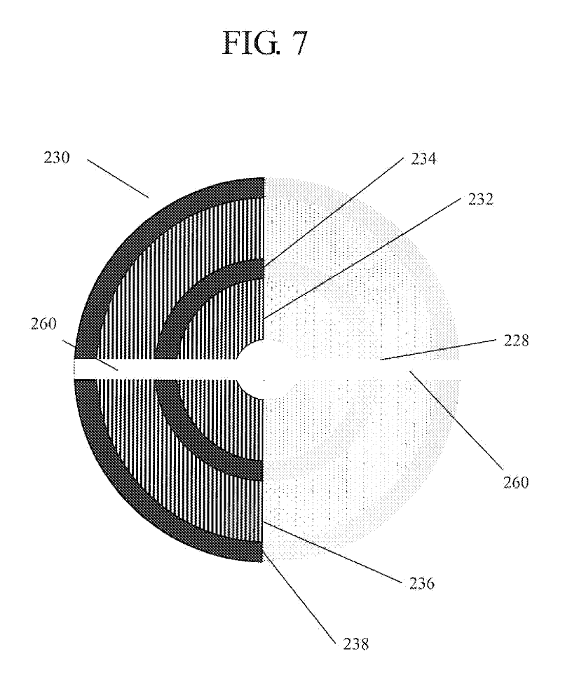

Example FIG. 7 illustrates a cross-section of a material in accordance with embodiments.

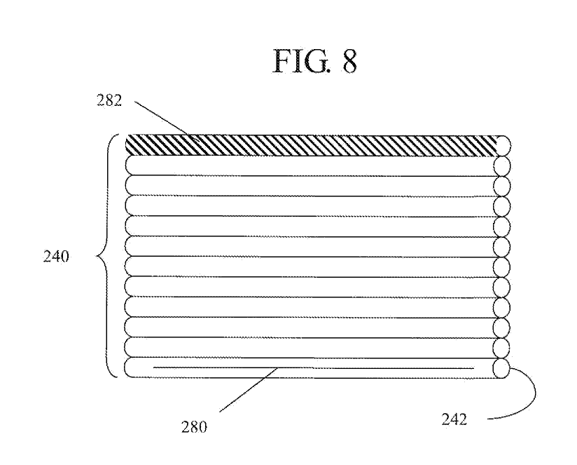

Example FIG. 8 illustrates a side view of a material in accordance with embodiments.

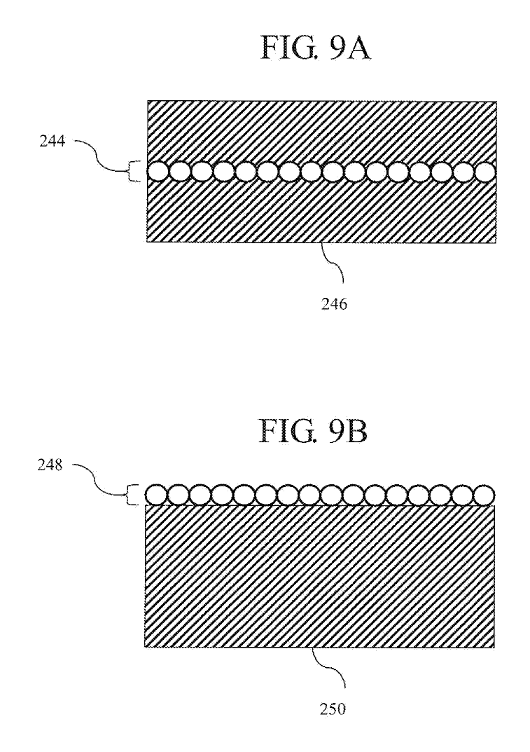

Example FIG. 9A to FIG. 9B illustrates a cross-section of a material in accordance with embodiments.

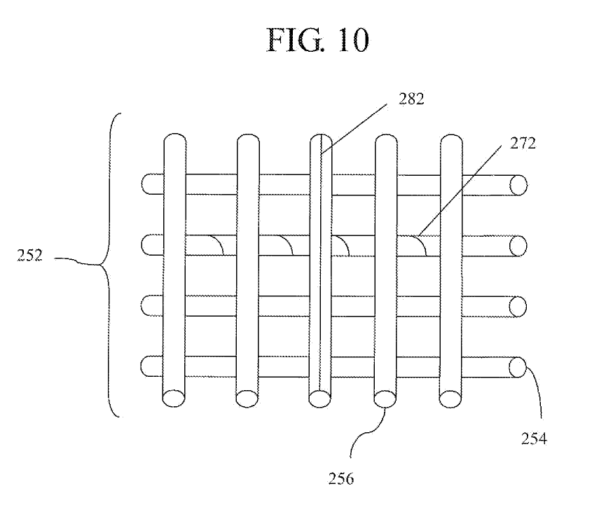

Example FIG. 10 illustrates a side view of a material in accordance with embodiments.

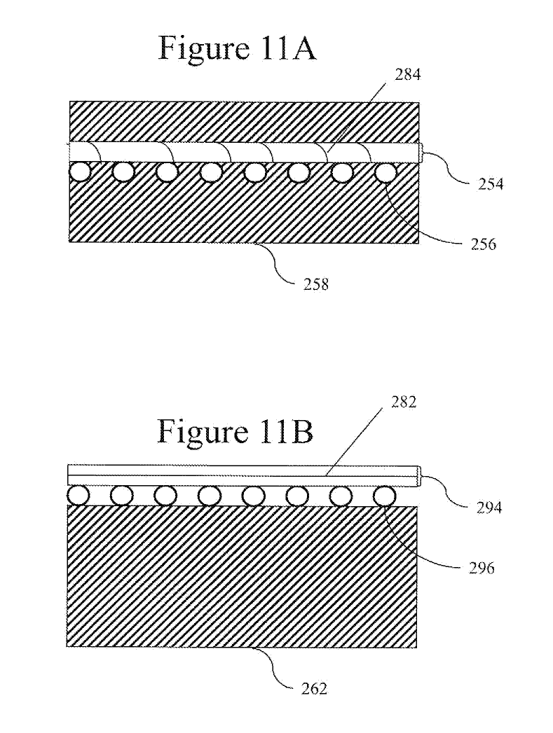

Example FIG. 11A to FIG. 11B illustrates a cross-section of a material in accordance with embodiments.

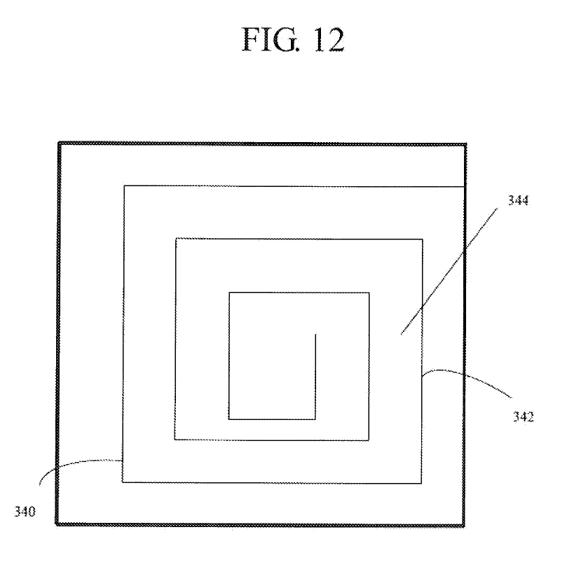

Example FIG. 12 illustrates a plan view of a material in accordance with embodiments.

### DESCRIPTION

Embodiments relate to an apparatus which may include a substantially well-defined pattern. According to embodiments, an apparatus may include a shape memory device, a display device, a radio frequency identification device, an integrated circuit, an optoelectronic device, and the like. In embodiments, a relatively even distribution of heat and/or current, and/or a predetermined heat and/or current path, may be provided.

Referring to example FIG. 1, a material in accordance with embodiments is illustrated. According to embodiments, an apparatus may include substrate layer 18 bonded to first linking agent material layer 16. In embodiments, first linking agent material layer 16 may be also bonded to first nano-particle material layer 14. In embodiments, first nano-particle material layer 14 may be also bonded to second linking agent material layer 12. In embodiments, second linking agent material layer 12 may be also bonded to second nano-particle material layer 10. Although only two linking agent layers (i.e. first linking agent material layer 16 and second linking agent material layer 12) and two nano-particle material layers (i.e. first nano-particle material layer 14 and second nano-particle material layer 10) are illustrated, embodiments may include any number of linking agent material layers and nano-particle material layers (including just one nano-particle material layer and/or linking agent material layer).

According to embodiments, first nano-particle material layer 14 may include a nano-particle, for example nanoparticles 22. In embodiments, nano-particles 22 may be conductive nano-particles (e.g. nano-size gold clusters). Nano-particles 22 may be individually bonded to first linking agent material layer 16. Bonding of nano-particles 22 to first linking agent material layer 16 may include electrostatic bonding and/or covalent bonding. Nano-particles 22 may not be substantially bonded to each other. Accordingly, in embodiments, as first linking agent material layer 16 expands or contracts or is otherwise strained, the bond between the nano-particles 22 and first linking agent material layer 16 is not significantly compromised.

According to embodiments, although nano-particles 22 in first nano-particle material layer 14 may not be bonded to each other, nano-particles 22 may be arranged close enough to each other, such that they may be electrically coupled to each other. In other words, in embodiments, electrical current may flow between adjacent nano-particles 22 in first nano-particle material layer 14. In fact, in embodiments, the rate of electrical conduction (i.e. electrical resistance) in first nano-particle material layer 14 (e.g. including gold nano-clusters) may be comparable and/or exceed that of solid gold (due to lattice inefficiencies in solid gold). Although, in one aspect of embodiments, straining or stretching of first linking material layer 16 may modify the resistance of first nano-particle material layer 14 (due to an increase in distance between neighboring nano-particles 22), first nano-particle material layer 14 may remain conductive even when stressed or strained.

According to embodiments, second linking agent material layer 12 may also be bonded to first nano-particle material layer 14, with the same or similar bonding mechanism as the bonding between first nano-particle material layer 14 and first linking agent material layer 16. In embodiments, first linking agent material layer 16 and second linking agent material layer 12 may include the same material and/or configuration. In embodiments, first linking agent material layer 16 and second linking agent material layer 12 may include different materials and/or configurations.

According to embodiments, second nano-particle material layer 10 may be bonded to second linking agent material layer 12 with the same or similar bonding mechanism as the bonding between first nano-particle material layer 14 and first linking agent layer 16. Additional linking agent material layer(s) and/or nano-particle material layer(s) may be formed over second nano-particle material layer 10, in accordance with embodiments. In embodiments, first nano-particle material layer 14 and second nano-particle material layer 10 may include the same material (i.e. nano-particles 20 and nano-particles 22 may be the same type of nano-particles) and/or configuration. In embodiments, first nano-particle material layer 14 and second nano-particle material layer 10 may include different materials (i.e. nano-particles 20 and nano-particles 22 may be different types of nano-particles) and/or configurations.

According to embodiments, nano-particles (e.g. nano-particles 20, nano-particles 22, and/or nano-particles 24) may be formed through a self-assembly. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles, in accordance with embodiments. In embodiments, the size (i.e. diameter or substantial diameter) of the nano-particles may be less than approximately 1000 nanometer. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, and/or mixtures of different types of materials. In embodiments, nano-particles may be semiconductor materials.

According to embodiments, through self-assembly, nano-particles may be substantially uniformally and/or spatially dispersed during deposition to form a self-assembled film. The self-assembly of nano-particles may utilize electrostatic and/or covalent bonding of the individual nano-particles to a host layer (e.g. a linking agent material layer and/or a shape memory material layer). A host layer may be polarized in order to allow for the nano-particles to bond to the host layer, in accordance with embodiments. Since the deposition of the nano-particles may be dependent on individual bonding of the nano-particles to the host layer, a nano-particle material layer may have a thickness that is approximately the diameter of the individual nano-particles. Through a self-assembly deposition method, nano-particles that do not bond to a host layer may be removed, so that a nano-particles material layer is formed that is relatively uniform in thickness and material distribution.

According to embodiments, linking agent material layer(s) (e.g. first linking agent material layer 16 and/or second linking agent material layer 12) may be a material that is capable of covalently and/or electrostaticly bonding to nano-particles, in accordance with embodiments. U.S. patent application Ser. No. 10/774,683 (which is incorporated by reference above) discloses examples of materials which may be included in linking agent material layer(s). Linking agent material layer(s) may include polymer material. In embodiments, the polymer material may include poly(urethane), poly(etherurethane), poly(esterurethane), poly(urethane)-co-(siloxane), poly(dimethyl-co-methylhydrido-co-3-cyanopropyl, methyl) siloxane, and/or other similar materials. Linking agent material layer(s) may include materials that are polarized, in order for bonding with nano-particles, in accordance with embodiments.

According to embodiments, linking agent material layer(s) may include a flexible material, an elastic material, and/or an elastomeric polymer. Accordingly, when nano-particles are bonded to sites of material in a linking agent material layer, a nano-particle material layer may assume the same elastic, flexible, and/or elastomeric attributes of the host linking agent material layer, in accordance with embodiments. This physical attribute may be attributed by the individual bonding of substantially each nano-particle (of a nano-particle material layer) to a site of the linking agent material layer through either covalent and/or electrostatic bonding. Accordingly, when a linking agent material layer is stretched, strained, and/or deformed, bonded nano-particles will move with sites of the linking agent material layer to which they are bonded, thus avoiding any disassociation of the nano-particles from their host during deformation.

Referring to example FIG. 2, a material in accordance with embodiments is illustrated. According to embodiments, a nano-particle material layer (e.g. third nano-particle material layer 26 with nano-particles 24) may be formed between first linking agent layer 16 and substrate layer 18. In other words, in embodiments, substrate layer 18 (e.g. shape memory material layer) may be bonded directly with a nano-particle material layer (e.g. third nano-particle material layer 26) or indirectly through a linking agent layer (e.g. first linking agent layer 16).

Referring to example FIG. 3A to FIG. 3C, an etching process and/or a material in accordance with embodiments is illustrated. According to embodiments, material 30 may include a nano-particle layer and/or a linking agent layer (e.g. first nano-particle layer 14 and/or first linking agent layer 16), which may form a portion of surface 32, as illustrated for example at FIG. 3A. In embodiments, surface 32 may be relatively smooth. In embodiments, surface 32 may be formed without a need for additional processing, for example planarization processes and/or surface treatments. In embodiments, surface 32 may be formed employing a self-assembly processes. In embodiments, surface 32 may have an average surface roughness less than approximately 100 nanometers, for example approximately 5 nanometers. In embodiments, material 30 may be electrostatically etched to form a substantially well-defined pattern.

According to embodiments, an electrostatic etching processes may be employed to pattern material 30 in a relatively predictable manner such that electrical, mechanical and/or thermal properties may be configured and/or maximized. In embodiments, the application of voltage across material 30 may result in the removal of a portion of surface 32, as illustrated for example at FIG. 3B and FIG. 3C. In embodiments, material 30 may include a precise etched portion, for example precise etched portion 34, which may result from breakdown of an electrostatic field through an electric arc. In embodiments, precise etched portion 34 may include an area substantially equal to the area of an etching portion of an electrostatic etching tool, for example approximately equal to the area of tip 36 of pointed probe and/or wire 38.

According to embodiments, a minimized voltage may be sufficient to form a pattern, for example approximately 20 V presented to surface 32. In embodiments, for example, an electrostatic patterning process may be employed to direct current efficiently over a relatively large area, for example greater than approximately 3″×3″ sheets of electrically conductive nanocomposites, in less than approximately 20 seconds employing relatively low voltage.

Referring to example FIG. 4, a material in accordance with embodiments is illustrated. As current travels in the path of least resistance, substantially well-defined patterns in accordance with embodiments may enable directed current path and/or heating. In a large sheet of conductive material, for example, it may not be possible to make the entire sheet of conductive material carry a sheet current, and/or a current that is substantially the same across the entire area of the sheet, for example due to imperfections in material and/or material distribution. In embodiments, a substantially well-defined pattern may enable a predetermined current and/or heat path. In embodiments, a relatively even distribution of heat and/or current may be provided.

According to embodiments, presenting a voltage across surface 42 may have a precise etched potion including line(s) and/or pattern(s). In embodiments, a complete and/or substantial elimination of electrical continuity of a conductor from separated surface areas may be implemented. In embodiments, precise etched portion 44 may include a print pattern, such as coil print 50 having a bend 52. In embodiments, a coil print may enable maximized manipulation of current path 54 and/or power (heat) distribution 56.

According to embodiments, any number of bends may be included having any desired thickness and/or electrical properties. In embodiments, for example, an approximately 1″×1″ material may include 5 bends, include a thickness of approximately 0.85 mm, and/or a resistance of approximately 10 ohm. In embodiments, for example, an approximately 1″×2″ material may include 5 bends, include a thickness of approximately 0.8 mm, and/or a resistance of approximately 35 ohm. In embodiments, for example, an approximately 1″×2″ may include 7 bends, include a thickness of approximately 0.8 mm, and/or a resistance of approximately 35 ohm. In embodiments, for example, an approximately 1″×3″ material may include 5 bends, include a thickness of approximately 0.8 mm, and/or a resistance of approximately 94 ohm. In embodiments, for example, an approximately 2″×2″ material may include 5 bends, include a thickness of approximately 0.8 mm, and/or a resistance of approximately 35 ohm. In embodiments, a pattern may not include any bends, for example having points and/or lines. In embodiments, a pattern may including bends that are formed at any desired angle across any desired axis and/or layer of a material.

Referring to example FIG. 5A to FIG. 5B, a precise etched portion in accordance embodiments is illustrated. According to embodiments, a precise etched portion may extend across any layer in any axis, and/or may be predetermined, for example by modifying the voltage applied and/or distance between a material and an etching tool. In embodiments, for example, precise etched portion 60 may traverse substrate layer 18, first linking agent layer 16, first nano-particle layer 14, second linking agent layer 12, and/or second nano-particle layer 10. In embodiments, a plurality of precise etched portions may be connected and/or disconnected. In embodiments, for example, precise etched portions 60 and precise etched portion 62 may be connected and/or disconnected.

According to embodiments, a precise etched portion may initially traverse one or more layers and gradually and/or abruptly change the layers it traverses as it moves from one area of a material to another area of a material. In embodiments, for example, a precise etched portion may initially traverse second linking agent layer 12 and second nano-particle layer 10, but traverse layers 18, 16, 14, 12 and 10 through an abrupt step-wise transition moving from one area of a material to another. In embodiments, as illustrated for example at FIG. 5A, precise etched portion 60 may extend between substrate layer 18 and second nano-particle layer 10. In embodiments, as illustrated for example at FIG. 5B, precise etched portion 62 may extend between first nano-particle layer 14 and second nano-particle layer 10.

Referring to example FIG. 6A to FIG. 6B, a material in accordance with embodiments is illustrated. In efforts to heat shape memory material through power dissipation from electric current, a current may include a single infinitesimally narrow path across a sheet of material. As a result, a shape memory material may not deform since a substantial portion of the sheet area may not experience power dissipation, and thus no heating, which may be important in the shape changing process. According to embodiments, processes and/or materials may maximize substantially even heat dissipation in a shape-memory material, for example employing a heat coil pattern for a conductive coating. In embodiments, processes and/or materials may enable predetermined and/or localized shape changes. In embodiments, electrically conductive, patterned, and/or shape memory thermoresponsive nanocomposites may undergo relatively large, rapid and/or repeated shape changes via application of heat and/or voltage. According, to embodiments, a self-assembly nanocomposite processing technique may be used to produce electrically conductive shape memory films and/or conformal coatings, which may have utility in highly efficient, low power morphing.

According to embodiments, shape memory material layer(s) (e.g. shape memory material layer 118) may be a material that has the ability to be deformed from its original shape, hold a new deformed shape for a predetermined period of time, and then return to its original shape again. Examples of shape memory materials are shape memory polymers and shape memory metal alloy, both which may be implemented in shape memory material layer 118, in accordance with embodiments. Shape memory polymer may be deformed from an original shape upon application of heat of the glass transition temperature (T_{g}). When heat above the glass transition temperature is applied, a shape memory polymer may be deformed into a new shape. If a shape memory polymer is cooled below the glass transition temperature while being deformed in the new shape, then the shape memory polymer will remain in the new shape.

Referring to FIG. 6A, a shape memory polymer material may have an original shape (e.g. the shape of shape memory material layer 118), with the material being unstrained. Upon application of strain and heat (above the glass transition temperature), the shape of the shape memory material may be deformed into a deformed shape, for example the shape of shape memory material layer 118 as illustrated at FIG. 6B. If the shape memory material is maintained in the deformed shape (e.g. through continuous application of strain) while being cooled below its glass transition temperature, then the deformed shape may be substantially maintained without the application of external strain. If the shape memory material in its deformed shape (e.g. the shape of shape memory material layer 118 at FIG. 6B) is heated again above its glass transition temperature (without the application of external strain), it will return to its original shape (e.g. the shape of shape memory material layer 118 in example FIG. 6A).

According to embodiments, shape memory material (e.g. shape memory material layer 118) may be covalently and/or electrostatically bonded to a linking agent material layer (e.g. first linking agent material layer 116 illustrated at FIGS. 6A and 6B) and/or a nano-particle material layer. In embodiments, materials of shape memory material may be polarized to enable electrostatic and/or covalent bonding.

According to embodiments, a shape memory material layer and linking agent material layer(s) may have the same, similar, and/or compatible elastic properties. In other words, when shape memory material layer is deformed through stress or straining, the elasticity of linking agent material layer(s) may not prevent a shape memory material layer from deforming. Since nano-particle material layer(s) include individual nano-particles that are independently bonding to an adjacent shape memory material layer(s) and/or linking agent material layer(s), nano-particle material layer(s) may not prevent a shape memory material from deforming, in accordance with embodiments. Further, during deformation of a shape memory material layer, nano-particle material layers may not be subjected to significant mechanical strain, since there is substantially no bonding between adjacent nano-particles in the nano-particle material layer(s), in accordance with embodiments.

Accordingly, applications of shape memory materials may extend to applications in aerospace technologies, automotive technologies, electronics, entertainment, and any other application where repeatable shape changing is a desired feature. As an example, in aerospace satellite applications, shape memory materials may be applied in deployable structures (e.g. a deployable antenna). For example, a deployable antenna formed of a flexible material may be compactly stored in a secure compartment during launching and orbiting of a satellite. Once in orbit, the antenna with shape memory materials may be deployed by application of heat (through electrodes). The shape memory material may be specifically tailored to have a glass transition temperature for specific applications. For example, in some satellite applications, the glass transition temperature may be tailored between approximately −127° C. and approximately 350° C., in accordance with embodiments. In embodiments, the glass transition temperature may be tailored to be above approximately 350° C. In embodiments, the glass transition temperature may be tailored to be below approximately −127° C. However, shape memory material may be tailored for virtually any glass transition temperature based on the application, in accordance with embodiments.

In embodiments, shape memory material may include at least one of a polysiloxane material, a polyurethane, and/or a siloxane-urethane copolymer. However, one of ordinary skill in the art would appreciate other similar materials that may be used, depending on the application, in accordance with embodiments. In embodiment, shape memory material may include at least one of fluorine, amine, thiol, phosphine, nitrile, phthalonitrile, hydroxyl, and/or a metal complexing moiety material. For example, at least one of polysiloxane, polyurethane, and or a siloxane-urethane copolymer may be fluorinated with fluorine to tailor the glass transition temperature. For example, a siloxane polymer may have a glass transition temperature of approximately −127° C. without fluorination, approximately −98° C. with a 50% mole percentage of fluorine, and −80° C. with a 100% mole percentage of fluorine, in accordance with embodiments. For example, a urethane polymer may have a glass transition temperature of approximately −75° C. without fluorination, approximately −28° C. with a 50% mole percentage of fluorine, and 3° C. with a 100% mole percentage of fluorine, in accordance with embodiments.

A glass transition temperature may be tailored by implementation of the Fox equation with the integration of two different shape memory materials. In the Fox equation,

$$\frac{1}{{T}_{g}} ≡ \frac{{W}_{1}}{{T}_{g 1}} + \frac{{W}_{2}}{{T}_{g 2}} ,$$

the glass transition temperature (T_{g}) of a shape memory material may be calculated and/or estimated by the relationship of the mole ratio (W₁) of a first shape memory material, the glass transition temperature of the first material (T_{g1}), the mole ratio (W₂) of a second shape memory material, the glass transition temperature of the second material (T_{g2}).

According to embodiments, an etching process may form a pattern, for example a coil pattern which may be etched lengthwise to the direction of shape change. In embodiments, a coil pattern may allow for substantial heat dissipation though the manipulation of the current path, and thus the power (heat) distribution. In embodiments, a predetermined current path may be the path of least resistance through a coil of a patterned conductive material, may allow for heat conduction and/or dissipation substantially evenly throughout a material, enabling shape change and/or memory of a material. In embodiments, with coiling for example, resistance of a material (e.g. elongated to the length of a coil) may relatively increase and relatively more voltage may be required to sink the same amount of current through the coil. In embodiments, this may be offset by allowing a relatively longer time for less current to heat up a material, with knowledge a minimum required current to heat material may be dependent on material properties.

Referring to example FIG. 7, a material in accordance with embodiments is illustrated. According to embodiments, a conductive nano-particle layer and/or a linking agent layer may be formed over a fiber to form flexible conductive fiber 230. In embodiments, first linking agent material layer 232 may be formed on fiber 228. In embodiments, first nano-particle material layer 234 may be formed on first linking agent material layer 232 by bonding (e.g. electrostatic bonding and/or covalent bonding) nano-particles to site of first linking agent material layer 232. In embodiments, additional linking agent material layers (e.g. second linking agent material layer 236) and nano-particle material layers (e.g. second nano-particle material layer 238) may be formed. Although only two linking agent layers (i.e. first linking agent material layer 232 and second linking agent material layer 236) and two nano-particle material layers (i.e. first nano-particle material layer 234 and second nano-particle material layer 238) are illustrated, embodiments may include any number of linking agent material layers and nano-particle material layers (including just one nano-particle material layer and/or linking agent material layer).

According to embodiments, linking agent material layers (i.e. first linking agent material layer 232 and second linking agent material layer 236) may be of a flexible material (e.g. an elastomeric polymer). Accordingly, conductive fiber 230 may be formed that has relatively highly conductive attributes and substantially maintain the physical flexibility and robustness of the host fiber, in accordance with embodiments.

According to embodiments, a precise etched portion may extend across any layer of film 230 in any axis, and/or may be predetermined. In embodiments, for example, precise etched portion 260 may traverse any portion of fiber 230. In embodiments, for example, precise etched portion 260 may traverse fiber 228, first linking agent layer 232, first nano-particle layer 234, second linking agent layer 236, and/or second nano-particle layer 238. In embodiments, a plurality of precise etched portions may be connected and/or disconnected. In embodiments, for example, precise etched portion 260 may include a helical pattern over fiber 230. In embodiments, precise etched portion may initially traverse one or more layers and gradually and/or abruptly change the layers it traverses as it moves from one area of a material to another area of a material. In embodiments, for example, precise etched portion 260 may initially traverse second linking agent layer 236 and second nano-particle layer 238, but traverse layers 232, 234, 236 and 238 through a gradual transition moving from one area of fiber 230 to another.

Referring to example FIG. 8, a material in accordance with embodiments is illustrated. According to embodiments, an apparatus may include a deregistered fiber array 240 (including conductive nano-particle layers). In embodiments, a fiber tow (e.g. a raw high performance fiber tow) may have its fibers 242 deregistered and subsequently processed to include nano-particle material layer(s), linking agent material layer(s) and/or precise etched portion(s) to form a conductive fiber array 240. In embodiments, for example, one or more fibers 242 including conductive nano-particle layer(s) and/or linking agent material layer(s) may include one or more precise etched portions. In embodiments, a precise etched portion may extend across any layer in any axis, and/or may be predetermined. In embodiments, for example as illustrated at FIG. 8, fibers 242 may be flanked by fiber 242 including a helical precise etched portion 282 and fiber 242 including a substantially straight precise etched portion 280 extending substantially from one end of fiber 242 to the other.

Referring to example FIG. 9A to FIG. 9B, a material in accordance with embodiments is illustrated. According to embodiments, deregistered fiber array 244 (including conductive nano-particle layer(s) and/or precise etched portion(s)) may be formed in an array that is integrated into a substrate, for example shape memory material 246. In embodiments, as illustrated for example at FIG. 9B, deregistered fiber array 248 (including conductive nano-particle layer(s) and/or precise etched portion(s)) may be formed in an array that is formed on and/or over a substrate, for example a shape memory material. In embodiments, fiber array 244 and/or fiber array 248 may be implemented as electrodes for generating heat in shape memory materials. Other embodiments include applications of a fiber array that are not in conjunction with shape memory materials. In embodiments, for example, a fiber and/or a fiber array may operate as a current channel in an integrated circuit, antenna in radio frequency identification devices, electrodes and/or wiring in displays, and the like.

Referring to example FIG. 10, a material in accordance with embodiments is illustrated. According to embodiments, mesh 252 of fibers (including conductive nano-particle layer(s) and/or precise etched portion(s)) may include fibers 256 that are spatially orientated in a first direction and fibers 254 that are orientated in a second direction different than the first direction. In embodiments, a mesh may be formed through a variety of different structural interrelationships between fiber (e.g. to form textiles). In embodiments, fibers 256 and/or fibers 254 may be processed, for example as illustrated at FIG. 7. In embodiments, a mesh (e.g. mesh 252) may be formed that is relatively highly conductive, yet maintains the flexibility of the host fibers, in accordance with embodiments. In embodiments, mesh 252 may include one or more precise etched portions, for example helical precise etched portion 272 and/or substantially straight etched portion 282, which may be oriented in the same, opposite and any suitable direction.

According to embodiments, mesh 252 of fibers may have many different applications. Referring to example FIG. 11A, a mesh of fibers (including conductive fibers 254 and 256) may be integrated into a substrate, for example shape memory material 258. In embodiments, fibers 254 and 256 may serve as an electrode, for example for shape memory material, displays, integrated circuits, and the like. Referring to example FIG. 11B, a mesh of fibers (including conductive fibers 294 and 296) may be formed over shape memory material, in accordance with embodiments. In embodiments, fibers 254 and/or 294 may include a precise etched portion, for example precise etched portion 284 illustrated at FIG. 11A and/or precise etched portion 282 illustrated at FIG. 11B.

According to embodiments, for example, a precise etched portion may be employed in any apparatus where it may be desired to include a substantially well-defined pattern, for example point(s), line(s) and/or coil(s). According to embodiments, for example, an apparatus may include a radio frequency identification device having a substantially well-defined pattern. In embodiments, patterns may be employed to form an antenna pattern, for example illustrated at example FIG. 12. In embodiments, a conductive nanocomposite may be electrostatically etched to form precise etched portion 340 having coil print 342, which may reside on and/or over any substrate.

According to embodiments, for example, a plastic substrate may include a nano-particle layer and/or a linking agent layer through a self-assembly process, which may be electrostatically etched in accordance with embodiments to form antenna 344 and/or employed in a radio frequency identification tag and/or reader. In embodiments, there would be no need for additional pre-processing steps such as pre-printing steps and/or post-processing steps such as pasting tags. In embodiments, process may be completely automated and producible on a production scale. Thus, according to embodiments, etching processes and/or materials may be employed in a wide array of technologies where a substantially well-defined pattern disposed on and/or over conductive, semiconductive and/or insulative material is desired, including in integrated circuits, optoelectronic devices, and/or display devices, and the like.

According to embodiments, aspects of embodiments are not limited to examples provided for illustration purposes. For example, in display and/or optoelectronic technologies, it may be desirable include a linking agent material having transparent and/or translucent properties, although flexibility may not be necessarily mutually exclusive. It may be desirable to form materials including insulative and/or semiconducting properties such that electrical properties may be configured and/or maximized. In embodiments, chemical compositions for self-assembling resins are not limited to, but may include block copolymers based on polyurethanes, acrylates, styrene, styrene-butadiene, siloxanes, isoprenes and the like.

Therefore, although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
at least one nano-particle layer; and
at least one linking agent layer, said at least one nano-particle layer bonded to said at least one linking agent layer;
wherein at least one of said at least one nano-particle layer and said at least one linking agent layer is electrostatically etched.

2. The apparatus of claim 1, comprising a shape memory material layer bonded to at least one of said at least one nano-particle layer and said at least one linking agent layer.

3. The apparatus of claim 2, wherein:
said at least one nano-particle layer is bonded to said at least one linking agent layer by at least one of electrostatic bonding and covalent bonding; and
at least one of said at least one nano-particle layer and said at least one linking agent layer are bonded to the shape memory material layer by at least one of electrostatic bonding and covalent bonding.

4. The apparatus of claim 2, wherein:
said at least one linking agent layer is an elastomeric polymer;
individual particles of said at least one nano-particle layer are bonded to sites of the elastomeric polymer; and
at least one of individual particles of said at least one nano-particle layer and sites of the elastomeric polymer are bonded to sites of the shape memory material layer.

5. The apparatus of claim 2, wherein:
said at least one nano-particle layer is comprised in an electrode; and
the electrode is configured to generate heat in the shape memory material through electricity to raise the shape memory material layer above the glass transition temperature of the shape memory material layer.

6. The apparatus of claim 5, wherein the electrode is substantially resilient to deformation of said at least one linking agent layer and said shape memory layer due to individual bonding of individual particles of said at least one nano-particle layer to at least one of said at least one linking agent layer and said shape memory material layer.

7. The apparatus of claim 2, wherein said shape memory material layer comprises at least one of fluorine, amine, thiol, phosphine, nitrile, phthalonitrile, hydroxyl, and a metal complexing moiety material.

8. The apparatus of claim 12, wherein at least one of said at least one nano-particle layer comprises nano-size particles including at least one of a metal, metal oxide, inorganic, organic, and semiconductor material.

9. The apparatus of claim 8, wherein said nano-size particles comprises gold clusters each having a diameter less than approximately 1000 nanometers.

10. The apparatus of claim 1, wherein at least one of said at least one linking agent layer comprises a polymer material including at least one of poly(urethane), poly(etherurethane), poly(esterurethane), poly(urethane)-co-(siloxane), poly(dimethyl-co-methylhydrido-co-3-cyanopropyl, methyl) siloxane.

11. The apparatus of claim 1, comprising at least one exposed surface including an average surface roughness less than approximately 100 nanometers.

12. The apparatus of claim 1, wherein said electrostatically etched at least one of said at least one nano-particle layer and said at least one linking agent layer comprises a precise etched portion.

13. The apparatus of claim 12, wherein the precise etched portion comprises an area substantially equal to the area of an etching portion of an electrostatic etching tool.

14. The apparatus of claim 12, wherein said precise etched portion is configured to result from breakdown of an electrostatic field through an electric arc.

15. The apparatus Of claim 1, wherein the precise etched portion comprises a print.

16. The apparatus of claim 15, wherein the print comprises a coil print including at least one bend.

17. The apparatus of claim 1, wherein said at least one nano-particle layer and said at least one linking agent layer are substantially transparent.

18. A method comprising:
forming at least one nano-particle layer;
forming at least one linking agent layer bonded to said at least one linking agent layer; and
electrostatically etching at least one of said at least one nano-particle layer and said at least one linking agent layer.

19. The method of claim 18, comprising forming a shape memory material layer bonded to at least one of said at least one nano-particle layer and said at least one linking agent layer.

20. The method of claim 18, comprising forming at least one of said at least one nano-particle layer and said at least one linking agent layer over a surface of a fiber.
